(19) United States
(12) Patent Application Publication
(10) Pub. No.: US 2005/0174283 A1
(43) Pub. Date: Aug. 11, 2005

(54) Location information notifying system and communication terminal

(75) Inventors: Ken Muramatsu, Kanagawa (JP); Wataru Tomiya, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO. LTD, OSAKA (JP)

(21) Appl. No.: 10/516,041

(22) PCT Filed: Dec. 22, 2003
(86) PCT No.: PCT/JP03/16463

(30) Foreign Application Priority Data
Dec. 26, 2002 (JP) 2002-377210

(51) Int. Cl. G01S 5/14

(52) U.S. Cl. 342/357.07; 342/357.1

(57) ABSTRACT

It is an object of the invention to provide a position information notification system in which communication terminals can mutually conduct a request for acquiring current position information and transmission of such information, and also a communication terminal which, even without an operation by the user, can calculate the current position of the terminal at predetermined timing and transmit current position information.

When a communication terminal issues a request for acquiring current position information of a GPS communication terminal, the request is sent to the GPS communication terminal. The GPS communication terminal calculates the current position on the basis of a radio wave from a GPS satellite, and sends current position information to the communication terminal. The GPS communication terminal (103) has: a current position information calculating section (203) which, when a first condition is satisfied, calculates the current position of the own terminal from the radio wave received through a GPS antenna (201); a wireless communication section (207) which, when a second condition is satisfied, transmits current position information in a predetermined form through a wireless communication antenna (205); a storage section (209) which stores the first and second conditions, the current position information, and the like; and a control section (211) which determines whether the conditions are satisfied or not, and converts the current position information to the predetermined form.

### TECHNICAL FIELD

The present invention relates to a position information notification system which notifies current position information of a communication terminal with a GPS function to another communication terminal, and also to a communication terminal.

### BACKGROUND ART

FIG. 4 shows an example of a conventional position information notification system in which a communication terminal that can receive a radio wave from a GPS satellite and acquire the current position notifies current position information of the own terminal to another communication terminal. In the conventional position information notification system, as shown in the figure, a management station 407 and base stations 404, 405 are connected to an exchange network 406, and a GPS communication terminal 401 which can receive a radio wave from a GPS satellite 402 and acquire the current position (hereinafter, this function is referred to as “GPS function”), and a communication terminal 403 without a GPS function are communicatable with the management station 407 through the base stations 404, 405 and the exchange network 406.

The GPS satellite 402 is a generic term for plural satellites which revolve around the earth and continue to transmit time information. The GPS communication terminal 401 receives time information from three or more of the satellites to calculate the current position of the own terminal. The GPS communication terminal 401 is previously registered in the management station 407.

Hereinafter, the operation of the conventional position information notification system will be described briefly. First, the communication terminal 403 issues a request for acquiring current position information of the GPS communication terminal 401, to the management station 407. Then, the management station 407 requests the GPS communication terminal 401 to transmit current position information. The GPS communication terminal 401 informs the user of the GPS communication terminal 401 that the request has been issued, by means of a display or sound, and waits for an operation which is to be conducted by the user to calculate the current position and transmit it to the management station 407. When the user conducts the operation on the GPS communication terminal 401, current position information is sent to the management station 407. Next, the management station 407 transmits the current position information received from the GPS communication terminal 401, to the communication terminal 403. Then, the communication terminal 403 displays the current position of the GPS communication terminal 401 on the basis of the current position information.

(Patent Reference 1) JP-A-2001-25054

(Patent Reference 2) JP-A-10-260244

In the above-described conventional position information notification system, the communication terminal 403 requests the GPS communication terminal 401 to acquire current position information, via the management station 407 in which the GPS communication terminal 401 is previously registered, and the GPS communication terminal 401 transmits the current position information to the communication terminal 403. Therefore, the management station 407 is an essential component. In other words, when the management station 407 is not interposed, neither a request for acquiring current position information nor transmission of such information can be conducted. When the management station 407 cannot be used because of a failure or the like, therefore, the system stops functioning. Therefore, it has been requested to develop a position information notification system in which communication terminals can mutually directly conduct a request for acquiring current position information and transmission of such information without interposing the management station 407.

In the GPS communication terminal 401 which has received from the management station 407 a request for acquiring current position information, in response to an operation by the user, the current position is calculated, and current position information is transmitted to the management station 407. Therefore, it has been requested to develop a communication terminal which, when the terminal receives a request for acquiring current position information, can calculate the current position of the terminal and transmit current position information, even without an operation by the user.

The invention has been conducted in view of the requests in the conventional art. It is an object of the invention to provide a position information notification system in which communication terminals can mutually conduct a request for acquiring current position information and transmission of such information, and also a communication terminal which, even without an operation by the user, can calculate the current position of the terminal at predetermined timing and transmit current position information.

### DISCLOSURE OF THE INVENTION

In order to attain the object, the communication terminal of the invention is a communication terminal which, when a first condition is satisfied, acquires a current position of the terminal on the basis of information transmitted from a GPS satellite, and transmits current position information indicative of the current position to another predetermined communication terminal, wherein the communication terminal comprises: condition determining means for determining whether the first condition is satisfied or not; current position calculating means for, when the first condition is satisfied, calculating the current position of the communication terminal on the basis of the information transmitted from the GPS satellite; and current position information transmitting means for transmitting current position information indicative of the current position calculated by the current position calculating means, to the other predetermined communication terminal. Even when an operation is not conducted by the user, therefore, the current position of the own terminal can be calculated at predetermined timing and transmitted to the other predetermined communication terminal.

Moreover, the communication terminal of the invention comprises current position information storing means for storing current position information indicative of latest current position calculated by the current position calculating means, and, when a second condition is satisfied, the current position information transmitting means transmits the current position information stored by the current position information storing means, to the other predetermined communication terminal. Even when an operation is not conducted by the user, therefore, the current position information of the own terminal can be transmitted to the other predetermined communication terminal.

Moreover, preferably, the communication terminal of the invention comprises information form converting means for converting the current position information to a predetermined form, and the current position information transmitting means transmits current position information which is converted by the information form converting means, to the other predetermined communication terminal.

Moreover, in the communication terminal of the invention, preferably, the first condition is whether it is a predetermined time or not, whether the present communication terminal enters a predetermined area or not, whether a call relating to a request for acquiring current position information is given from a predetermined telephone number or not, or whether a mail relating to a request for acquiring current position information is received from a predetermined mail address or not, and a user of the present communication terminal is enabled to set the first condition.

Moreover, in the communication terminal of the invention, preferably, the second condition is whether the current position information is to be transmitted immediately after the current position is calculated or not, whether it is a predetermined time or not, whether the present communication terminal enters a predetermined area or not, whether a call relating to a request for acquiring current position information is given from a predetermined telephone number or not, or whether a mail relating to a request for acquiring current position information is received from a predetermined mail address or not, and a user of the present communication terminal is enabled to set the second condition.

Moreover, in the communication terminal of the invention, preferably, the predetermined form includes a location name, map image data, or latitude and longitude information, and a user of the present communication terminal is enabled to set the predetermined form.

Moreover, in the communication terminal of the invention, preferably, the other predetermined communication terminal is a communication terminal which conducts the request for acquiring current position information, or a communication terminal which is designated by a user of the present communication terminal.

The position information notification system of the invention comprises: a communication terminal according to claim 1, 2, 3, 4, 5, 6, or 7; the other predetermined communication terminal; and an exchange network through which the communication terminal according to claim 1, 2, 3, 4, 5, 6, or 7 is communicatable with the other predetermined communication terminal. Therefore, the communication terminals can mutually conduct a request for acquiring current position information and transmission of such information.

### BRIEF DESCRIPTION OF THE DRAWINGS

FIG. 1 is a diagram showing a position information notification system of an embodiment of the invention;

FIG. 2 is a block diagram showing the internal configuration of a GPS communication terminal constituting the position information notification system of the embodiment of the invention;

FIG. 3 is a view showing examples of displays for selecting various conditions in the GPS communication terminal; and

FIG. 4 is a diagram showing a conventional position information notification system.

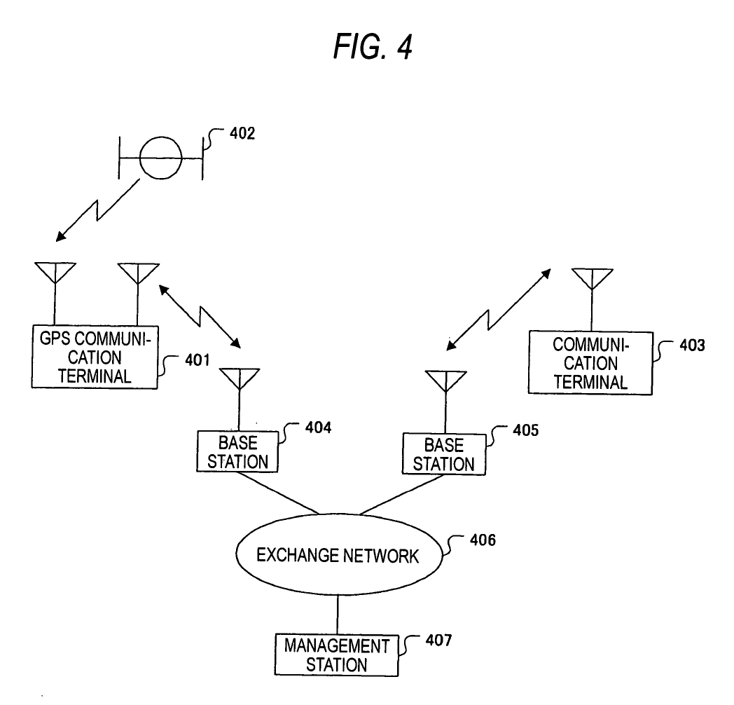

In the figures, the reference numeral 101 denotes a GPS satellite, 103 denotes a GPS communication terminal, 105 denotes a communication terminal, 107, 109 denote a base station, 111 denotes an exchange network, 201 denotes a GPS antenna, 203 denotes a current position information calculating section, 205 denotes a wireless communication antenna, 207 denotes a wireless communication section, 209 denotes a storage section, 211 denotes a control section, 251 denotes a current position information calculating condition storage section, 253 denotes a current position information transmitting condition storage section, 255 denotes a current position information form storage section, and 257 denotes a current position information storage section.

### BEST MODE FOR CARRYING OUT THE INVENTION

Hereinafter, an embodiment of the position information notification system and communication terminal of the invention will be described in detail with reference to the drawings.

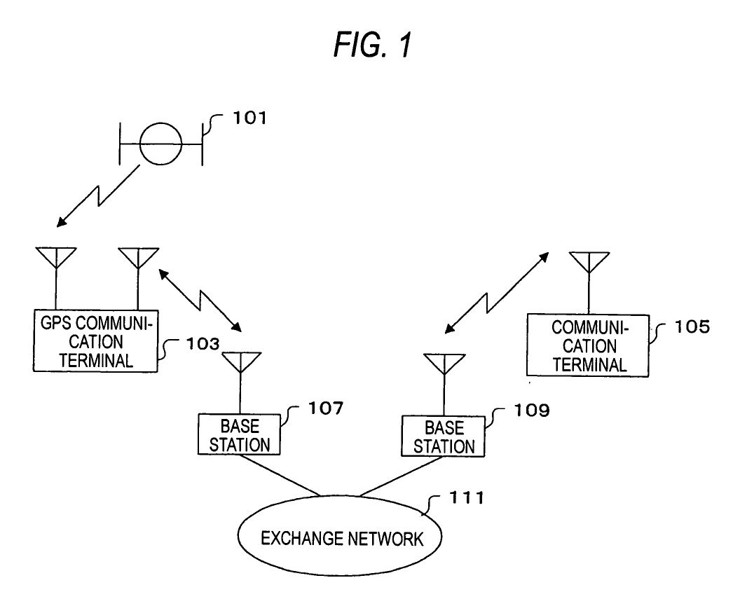

FIG. 1 is a diagram showing the position information notification system of the embodiment of the invention. As shown in the figure, the position information notification system of the embodiment comprises: a GPS satellite 101; a GPS communication terminal 103 corresponding to the communication terminal set forth in the claims; a communication terminal 105 corresponding to the other predetermined communication terminal; base stations 107, 109; and an exchange network 111. The base stations 107, 109 are connected to the exchange network, and the GPS communication terminal 103 and the communication terminal 105 are communicatable with each other through the base stations 107, 109 and the exchange network 111. The GPS satellite 101 is a generic term for plural satellites which revolve around the earth and continue to transmit time information.

In the embodiment, when the communication terminal 105 issues a request for acquiring current position information of the GPS communication terminal 103, the request is sent to the GPS communication terminal 103 through the exchange network 111. The GPS communication terminal 103 calculates the current position of the own terminal on the basis of time information received from three or more of the satellites, and sends current position information to the communication terminal 105 through the exchange network 111.

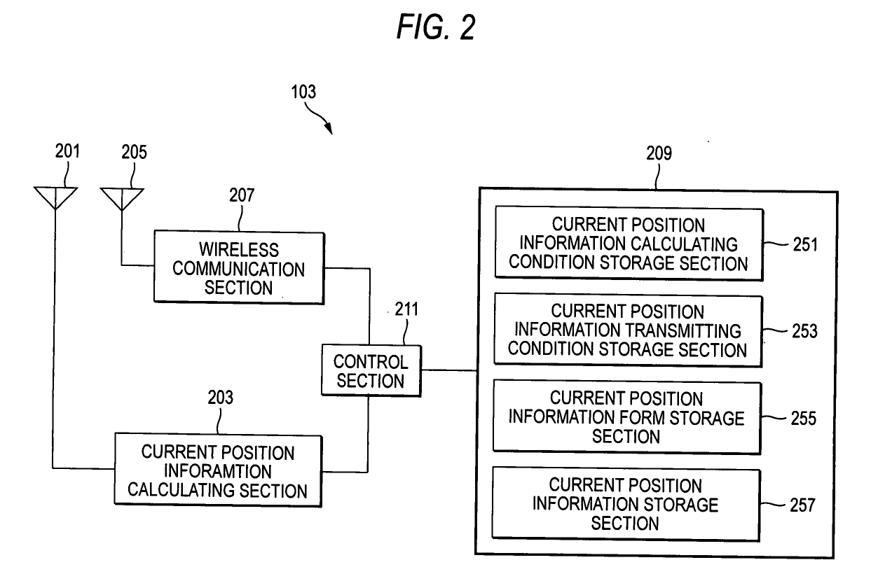

Hereinafter, the GPS communication terminal 103 constituting the position information notification system of the embodiment will be described in detail with reference to FIG. 2. As shown in the figure, the GPS communication terminal 103 has: a GPS antenna 201; a current position information calculating section 203 corresponding to the current position calculating means set forth in the claims; a wireless communication antenna 205; a wireless communication section 207 corresponding to the current position information transmitting means; a storage section 209; and a control section 211 corresponding to the condition determining means and the information form converting means.

Hereinafter, the components of the GPS communication terminal 103 will be described.

First, the GPS antenna 201 is an antenna for receiving time information transmitted from the GPS satellite 101. The current position information calculating section 203 calculates the current position of the own terminal at predetermined timing which will be described later, from the time information received through the GPS antenna 201.

The wireless communication antenna 205 is an antenna for communicating with a base station which is near the place where the GPS communication terminal 103 is located. The wireless communication section 207 conducts demodulation and the like on a signal received through the wireless communication antenna 205, and modulation and the like on a transmission signal. The current position information calculated by the current position information calculating section 203 is subjected to modulation and the like in the wireless communication section 207, and transmitted at predetermined timing which will be described later, from the wireless communication antenna 205 to the communication terminal 105 through the base stations 107, 109 and the exchange network 111.

The storage section 209 stores programs for causing the GPS communication terminal 103 to operate, and includes a current position information calculating condition storage section 251, a current position information transmitting condition storage section 253, a current position information form storage section 255, and a current position information storage section 257. The current position information storage section 257 corresponds to the current position information storing means set forth in the claims.

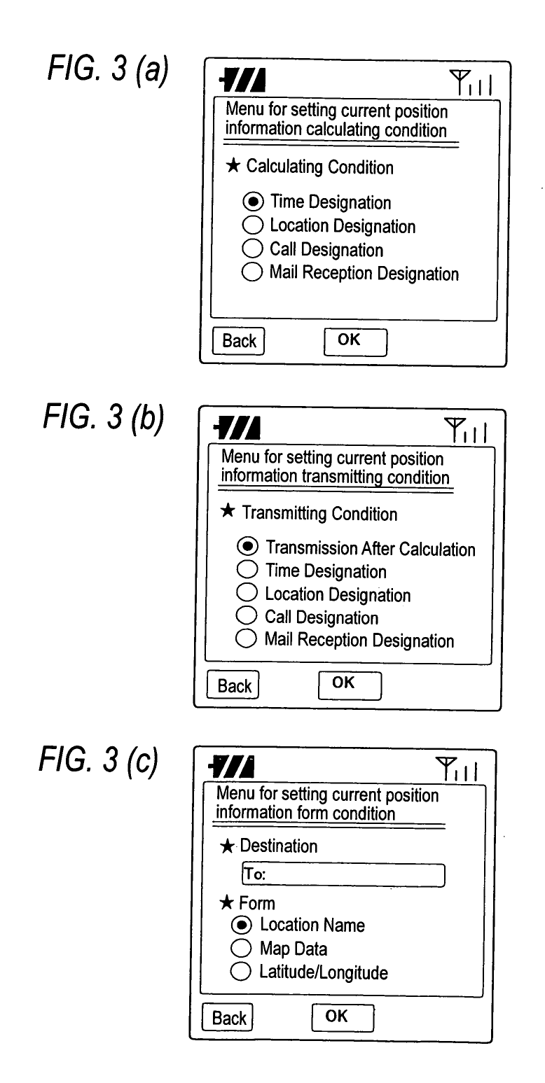

The current position information calculating condition storage section 251 stores a condition (current position information calculating condition) under which the current position information calculating section 203 is allowed to calculate the current position of the own terminal from the time information received through the GPS antenna 201. The current position information calculating condition corresponds to the first condition set forth in the claims. As shown in FIG. 3(a), the current position information calculating condition includes: (a) “Time designation” in which the current position is calculated at a specific time; (b) “Location designation” in which the current position is calculated when the GPS communication terminal 103 enters a specific area; (c) “Call designation” in which the current position is calculated when a call relating to a request for acquiring current position information is given from a specific telephone number; and (d) “Mail reception designation” in which the current position is calculated when a mail relating to a request for acquiring current position information is received from a specific mail address. The user of the GPS communication terminal 103 can select one of these designations, and designate the time, the area, the telephone number, and the mail address.

The current position information transmitting condition storage section 253 stores a condition (current position information transmitting condition) under which the current position information of the GPS communication terminal 103 calculated by the current position information calculating section 203 is allowed to be transmitted to the communication terminal 105. The current position information transmitting condition corresponds to the second condition set forth in the claims. As shown in FIG. 3(b), the current position information transmitting condition includes: (a) “Transmission after calculation” in which transmission is conducted immediately after the current position is calculated; (b) “Time designation” in which transmission is conducted at a specific time; (c) “Location designation” in which transmission is conducted when the GPS communication terminal 103 enters a specific area; (d) “Call designation” in which transmission is conducted when a call relating to a request for acquiring current position information is given from a specific telephone number; and (e) “Mail reception designation” in which transmission is conducted when a mail relating to a request for acquiring current position information is received from a specific mail address. The user of the GPS communication terminal 103 can select one of these designations, and designate the time, the area, the telephone number, and the mail address.

The current position information form storage section 255 stores the form and destination of current position information which is to be transmitted from the GPS communication terminal 103. As shown in FIG. 3(c), the form includes: (a) “Location name” in which current position information is a place name, a building name, or the like; (b) “Map data” in which current position information is map image data; and (c) “Latitude/longitude” in which current position information is latitude and longitude data. The user of the GPS communication terminal 103 can select one of these designations. The destination of current position information can be input or selected. Hereinafter, the form of current position information and the destination of current position information are referred to as “current position information form condition”.

The current position information storage section 257 is used for, in a case such as that where a current position is not immediately transmitted even when the current position information calculating section 203 calculates the current position, storing current position information until at least transmission is conducted. Even in a case where transmission is conducted immediately after the current position is calculated, however, the current position information may be once stored into the current position information storage section 257. In the current position information storage section 257, the latest one of current positions calculated by the current position information calculating section 203 is stored, and information related to previous current positions is deleted.

FIGS. 3(a) to 3(c) which have been referenced above show examples of displays for selecting various conditions in a display section (not shown) of the GPS communication terminal 103.

The control section 211 determines whether the conditions stored in the storage section 209 are satisfied or not, instructs the current position information calculating section 203 to calculate the current position, instructs the wireless communication section 207 to transmit current position information, reads out the conditions from the storage section 209, writes the conditions into the storage section 209, and reads out and writes current position information. Furthermore, the control section 211 converts current position information to the form stored in the current position information form storage section 255.

Next, the operation of the GPS communication terminal 103 will be described briefly. It is assumed that, in the GPS communication terminal 103, the current position information calculating condition is set to “Time designation” of ten o'clock a.m., the current position information transmitting condition is set to “Call designation”, and the current position information form condition is set to “Map data” and “Communication terminal 105”.

At ten o'clock a.m., the GPS communication terminal 103 calculates the current position of the own terminal from time information received through the GPS antenna 201, and writes current position information into the current position information storage section 257. When a call relating to a request for acquiring current position information is then given from the communication terminal 105, the GPS communication terminal 103 reads out the current position information from the current position information storage section 257, converts the information in the control section 211 into map image data, and then transmits the map image data from the wireless communication antenna 205 to the communication terminal 105 through the exchange network 111.

As described above, according to the position information notification system and the GPS communication terminal 103 of the embodiment, the communication terminal 105 and the GPS communication terminal 103 can mutually conduct a request for acquiring current position information and transmission of such information through the exchange network 111. Therefore, a management station which is necessary in the conventional art is not required, so that a situation in which the whole system cannot be used does not occur. The GPS communication terminal 103 can select the timings to calculate and transmit current position information, and the form of the current position information, and the calculation and the transmission do not require an operation by the user. Even when an operation is not conducted by the user, therefore, the current position can be calculated at predetermined timing, and current position information can be transmitted. Moreover, current position information can be converted into a predetermined form and then transmitted.

While the invention has been described in detail with reference to a specific embodiment, it will be understood by those skilled in the art that various changes and modifications can be made without departing from the spirit and scope of the invention.

This application is based on Japanese patent application No. 2002-377210 filed Dec. 26, 2002, and the contents of the patent application are incorporated herein by reference.

### Industrial Applicability

As described above, according to the position information notification system of the invention, communication terminals can mutually conduct a request for acquiring current position information and transmission of such information. According to the communication terminal of the invention, even without an operation by the user, it is possible to calculate the current position of the terminal at predetermined timing and transmit current position information.

1. A communication terminal which, when a first condition is satisfied, acquires a current position of the terminal on the basis of information transmitted from a GPS satellite, and transmits current position information indicative of the current position to another predetermined communication terminal, wherein
the communication terminal comprises:
condition determining means for determining whether the first condition is satisfied or not;
current position calculating means for, when the first condition is satisfied, calculating the current position of the communication terminal on the basis of the information transmitted from the GPS satellite; and
current position information transmitting means for transmitting current position information indicative of the current position calculated by the current position calculating means, to the other predetermined communication terminal.

2. The communication terminal according to claim 1, wherein the communication terminal comprises current position information storing means for storing current position information indicative of latest current position calculated by the current position calculating means, and
when a second condition is satisfied, the current position information transmitting means transmits the current position information stored by the current position information storing means, to the other predetermined communication terminal.

3. The communication terminal according to claim 1 or 2, wherein the communication terminal comprises information form converting means for converting the current position information to a predetermined form, and
the current position information transmitting means transmits current position information which is converted by the information form converting means, to the other predetermined communication terminal.

4. The communication terminal according to claim 1, 2, or 3, wherein the first condition is whether it is a predetermined time or not, whether the present communication terminal enters a predetermined area or not, whether a call relating to a request for acquiring current position information is given from a predetermined telephone number or not, or whether a mail relating to a request for acquiring current position information is received from a predetermined mail address or not, and
a user of the present communication terminal is enabled to set the first condition.

5. The communication terminal according to claim 2, 3, or 4, wherein the second condition is whether the current position information is to be transmitted immediately after the current position is calculated or not, whether it is a predetermined time or not, whether the present communication terminal enters a predetermined area or not, whether a call relating to a request for acquiring current position information is given from a predetermined telephone number or not, or whether a mail relating to a request for acquiring current position information is received from a predetermined mail address or not, and
a user of the present communication terminal is enabled to set the second condition.

6. The communication terminal according to claim 3, 4, or 5, wherein the predetermined form includes a location name, map image data, or latitude and longitude information, and
a user of the present communication terminal is enabled to set the predetermined form.

7. The communication terminal according to claim 1, 2, 3, 4, 5, or 6, wherein the other predetermined communication terminal is a communication terminal which conducts the request for acquiring current position information, or a communication terminal which is designated by a user of the present communication terminal.

8. A position information notification system comprising:
a communication terminal according to claim 1, 2, 3, 4, 5, 6, or 7;
the other predetermined communication terminal; and
an exchange network through which the communication terminal according to claim 1, 2, 3, 4, 5, 6, or 7 is communicatable with the other predetermined communication terminal.
